(19) United States
(12) Patent Application Publication
(10) Pub. No.: US 2024/0029329 A1
(43) Pub. Date: Jan. 25, 2024

(54) Mitigation of Animation Disruption in Artificial Reality

(71) Applicant: Meta Platforms Technologies, LLC, Menlo Park, CA (US)

(72) Inventors: William Arthur Hugh STEPTOE, London (GB); Michael James LEBEAU, Amsterdam (NL); Alisa KURT, Hackney (GB); Raphael GUILLEMINOT, Romainville (FR)

(21) Appl. No.: 17/868,012

(22) Filed: Jul. 19, 2022

(51) Int. Cl. G06T 13/40; G06F 3/01; G06T 13/80; G06F 3/041

(52) U.S. Cl. CPC G06T 13/40; G06F 3/011; G06T 13/80; G06F 3/041; G06F 2203/04101; G06T 2213/12

(57) ABSTRACT

Technology described herein is directed to mitigating avatar display disruption, in an artificial reality environment, resulting from losses in user tracking. The technology can use an artificial reality device to continually determine contextual characteristics of the user that can correspond to placements of one or more portions of the user's body with respect to another portion thereof and/or one or more real-world objects. A user state, corresponding to a contextual characteristic occurring at a time of an interruption in the tracking, can define a bodily configuration of the user that can be with respect to the one or more real-world objects when the interruption occurs. The technology can, according to an avatar pose assigned to the user state, animate the avatar to the assigned pose when the interruption occurs and immediately reinitiate animation from that pose upon regaining tracking of the user's pose.

### TECHNICAL FIELD

The present disclosure is directed to mitigating avatar display disruption, in an artificial reality environment, resulting from losses in user tracking.

### BACKGROUND

Artificial reality systems afford their users opportunities to experience a myriad of settings where engagements can be highly interactive, fast-paced, and/or unpredictable. As is commonly understood, these systems employ avatars to convey users' interactions for an artificial reality environment sometimes portraying a particular real-world setting. In other words, an avatar serves as the vehicle by which a user is manifested for the artificial reality experience. In these regards, a user can select, from among avatar options available for the experience, an avatar that provides an appropriate representation of the user. For instance, the particular avatar may be configured to express certain gestures or perform certain actions that would be suitable to convey the user's demeanor and/or activity.

### BRIEF DESCRIPTION OF THE DRAWINGS

FIG. 1 is a block diagram illustrating an overview of devices on which some implementations of the present technology can operate.

FIG. 2A is a wire diagram illustrating a virtual reality headset which can be used in some implementations of the present technology.

FIG. 2B is a wire diagram illustrating a mixed reality headset which can be used in some implementations of the present technology.

FIG. 2C is a wire diagram illustrating controllers which, in some implementations, a user can hold in one or both hands to interact with an artificial reality environment.

FIG. 3 is a block diagram illustrating an overview of an environment in which some implementations of the present technology can operate.

FIG. 4 is a block diagram illustrating components which, in some implementations, can be used in a system employing the disclosed technology.

FIG. 5 is a flow diagram illustrating a process used in some implementations of the present technology for animating an avatar in response to interruptions in tracking a user's pose.

FIG. 6 is a flow diagram illustrating a process used in some implementations of the present technology for animating an avatar in response to tracking of a user's pose being partially interrupted.

FIG. 7 is a flow diagram illustrating a process used in some implementations of the present technology for selecting an avatar pose to which an avatar can be animated following detection of an interruption in tracking of a user's pose.

FIG. 8 is a conceptual diagram illustrating an example kinematic model.

FIG. 9 is a conceptual diagram illustrating, according to implementations of the present technology, an avatar having a rest pose matching a first user state identified for a user following an interruption in tracking of the user's pose.

FIG. 10 is a conceptual diagram illustrating, according to implementations of the present technology, an avatar having a rest pose matching a second user state identified for a user following an interruption in tracking of the user's pose.

FIG. 11 is a conceptual diagram illustrating, according to implementations of the present technology, an avatar having a rest pose matching a third user state identified for a user following an interruption in tracking of the user's pose.

FIG. 12 is a conceptual diagram illustrating, according to implementations of the present technology, an avatar having a rest pose matching a fourth user state identified for a user following an interruption in tracking of the user's pose.

The techniques introduced here may be better understood by referring to the following Detailed Description in conjunction with the accompanying drawings, in which like reference numerals indicate identical or functionally similar elements.

### DETAILED DESCRIPTION

Aspects of the present disclosure are directed to mitigating avatar display disruption, in an artificial reality (XR) environment, resulting from losses in user tracking. Such mitigation can be achieved, for example, by detecting an interruption in pose tracking (i.e., motion and/or position) by an XR system user represented by the avatar, and then responsively animating the avatar to a rest pose from which animation can be continued once tracking of the user's pose is regained.

For instance, the XR system can continually track user pose data as well as data for one or more real-world objects in a vicinity of the user, and indicate to the user any interruption in the tracking of the pose data. As a result of the indication, the user can understand that further interactions may not be accurately depicted by the avatar. Further, the avatar can be animated in a way that does not reflect erratic, inaccurate tracking data. The XR system can identify a user state, and while the tracking data is incomplete, use the state to select a rest pose to which the avatar can be animated. In this regard, the user state can, for example, define a static or dynamic configuration of one or more portions of the user's body compared to another body portion and/or the one or more real-world objects. To identify an applicable user state, the XR system can implement a machine learning model trained to generate a kinematic (i.e., body) model of the user. The kinematic model can define, according to anatomical capabilities and constraints, a current body configuration of the user to which one more positional rules can be applied. Applications of these positional rules to the kinematic model and the data tracked for the one or more real-world objects can define one or more contextual characteristics that can correspond to a placement of one or more portions of the user's body. Using a mapping of contextual characteristics to user states, the XR system can then select a user state that corresponds to the one or more contextual characteristics resulting from the body configuration given by the kinematic model.

Since each of the user states in the mapping above correspond to an assigned avatar rest pose, the XR system can, in response to a detected interruption in tracking user pose, automatically animate the avatar to the rest pose assigned to the selected user state. In these regards, the XR system can, throughout a user's interactions for an XR environment, track user pose to continually identify applicable user states for a user. A corresponding avatar pose for a selected user state can, in response to an interruption in the tracking, be made immediately available as a restoration point from which the avatar can continued to be animated. Accordingly, since the selected user state is the one that most nearly approximates the user's pose at the time of the interruption a gap in animation for an avatar can minimized disruption of the user's experience.

In an example implementation of the present technology, the XR system can track both a user's pose for a user's interactions for an XR office environment as well as one or more positions of real-world objects for that environment. For example, such an object can be a worktop of a desk or other flat-topped surface. The system can then identify a user state for the tracked pose of the user and positioning of the worktop by executing a number of steps. First, the system can apply the pose data to a machine learning model trained to generate a kinematic model for the user. Second, the system can apply one or more positional rules to the kinematic model and the positioning data for the worktop, where applications of the rules can define one more contextual characteristics of the user. In this example, one or more of such characteristics can correspond to a positioning of a user's hand and/or hands with respect to the worktop, e.g., “user's hand or hands are on worktop.” Third, the system can, in order to arrive at the user state to be identified, select the applicable user state from among a mapping of contextual characteristics to user states assigned to avatar poses. For instance, the mapping can indicate that the user state which is applicable for the above contextual characteristic is a user state of, “user is seated at worktop.” Thus, the XR system can then, upon detecting an interruption in tracking the user's pose, animate an avatar, corresponding to the user, to the respectively assigned avatar pose as a restoration point from which to continue animation.

Embodiments of the disclosed technology may include or be implemented in conjunction with an artificial reality system. Artificial reality or extra reality (XR) is a form of reality that has been adjusted in some manner before presentation to a user, which may include, e.g., virtual reality (VR), augmented reality (AR), mixed reality (MR), hybrid reality, or some combination and/or derivatives thereof. Artificial reality content may include completely generated content or generated content combined with captured content (e.g., real-world photographs). The artificial reality content may include video, audio, haptic feedback, or some combination thereof, any of which may be presented in a single channel or in multiple channels (such as stereo video that produces a three-dimensional effect to the viewer). Additionally, in some embodiments, artificial reality may be associated with applications, products, accessories, services, or some combination thereof, that are, e.g., used to create content in an artificial reality and/or used in (e.g., perform activities in) an artificial reality. The artificial reality system that provides the artificial reality content may be implemented on various platforms, including a head-mounted display (HMD) connected to a host computer system, a standalone HMD, a mobile device or computing system, a “cave” environment or other projection system, or any other hardware platform capable of providing artificial reality content to one or more viewers.

“Virtual reality” or “VR,” as used herein, refers to an immersive experience where a user's visual input is controlled by a computing system. “Augmented reality” or “AR” refers to systems where a user views images of the real world after they have passed through a computing system. For example, a tablet with a camera on the back can capture images of the real world and then display the images on the screen on the opposite side of the tablet from the camera. The tablet can process and adjust or “augment” the images as they pass through the system, such as by adding virtual objects. “Mixed reality” or “MR” refers to systems where light entering a user's eye is partially generated by a computing system and partially composes light reflected off objects in the real world. For example, a MR headset could be shaped as a pair of glasses with a pass-through display, which allows light from the real world to pass through a waveguide that simultaneously emits light from a projector in the MR headset, allowing the MR headset to present virtual objects intermixed with the real objects the user can see. “Artificial reality,” “extra reality,” or “XR,” as used herein, refers to any of VR, AR, MR, or any combination or hybrid thereof.

Existing XR systems attempt continual animation of an avatar portraying a user's interactions for an XR environment. By doing so, these systems risk losing coordination of a user's signaling for that animation, and even more, risk not recognizing an appropriate reference point from which to reinitiate animation after signaling has been lost. In other words, these architectures fail to properly coordinate, in a case where tracking for a user has been lost, when and how to manage animation of an avatar in response to the loss, causing jerky and inaccurate avatar representations.

By contrast, implementations of the present technology resolve discontinuities in animation that can result from losing tracking of a user's pose for an avatar. In particular, implementations of the present technology can recognize that the tracking has been lost (i.e., interrupted, is below a confidence level, etc.) and indicate the same to a user. As this notification occurs, an XR system according to the present implementations can, for the tracking loss, identify a user state corresponding to an avatar pose. For instance, the XR system can implement tracking for user pose and one or more objects in a vicinity of the user to identify the user state. As an example, the XR system can implement machine learning to determine a kinematic model of the user, and thereafter determine one or more contextual characteristics of the user via application of one or more positional rules to both the model and the tracked object data. These contextual characteristics can then guide selection, by the XR system, of a user state, assigned to an avatar pose, from a mapping between contextual characteristics and such user states. Having now made a selection for the user state corresponding to the interruption in tracking user pose, the XR system according to the present technology can then animate the avatar in the XR environment to a rest pose, i.e., the avatar pose assigned to that user state.

In these ways, therefore the present XR system can readily establish, for the tracked loss in user pose, the above rest pose as a reference point from which to reinitiate animation once tracking for the user's pose is regained. As such and unlike conventional XR systems, the XR system according to the present technology can avoid discontinuity in animating an avatar when tracking for a user's pose is lost. This is particularly the case as the present XR system can notify a user of an interruption in tracking, while, at the same time, a rest pose corresponding to that interruption is implemented as a reference point from which to reinitiate animation.

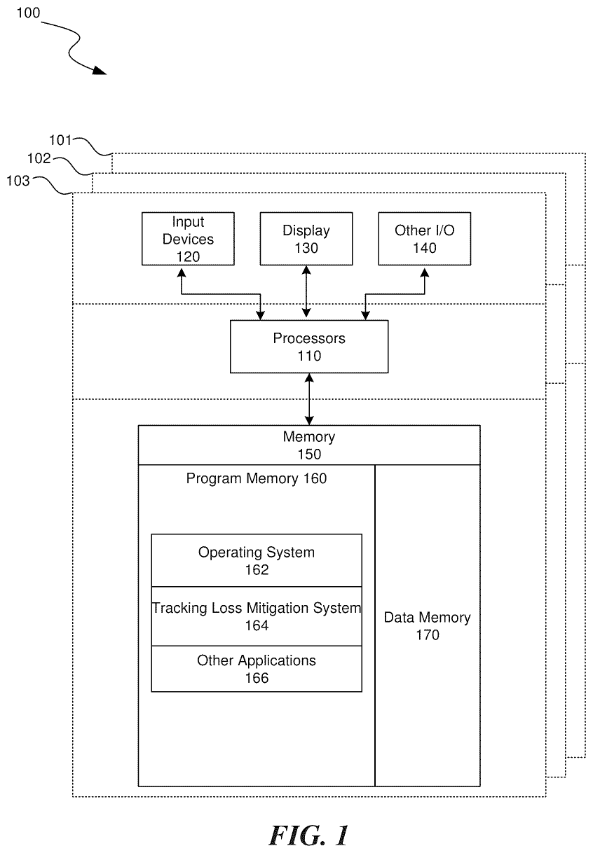

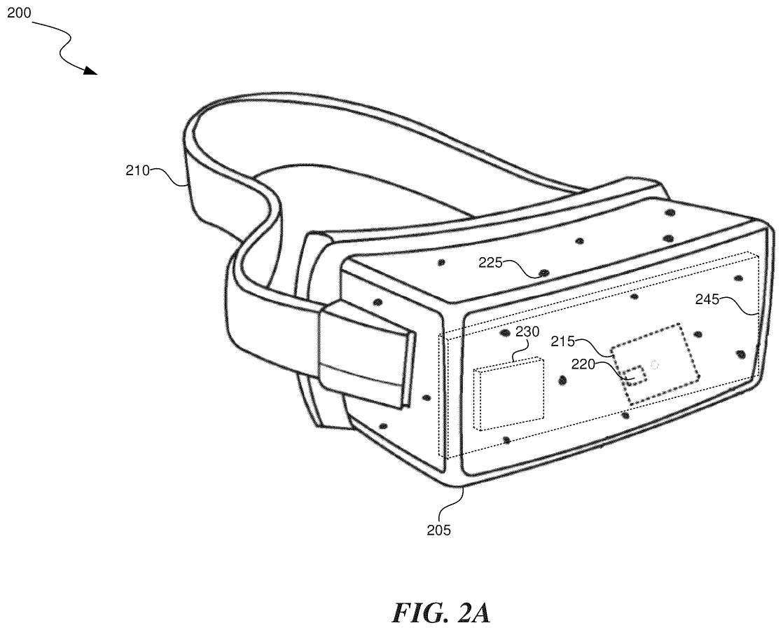

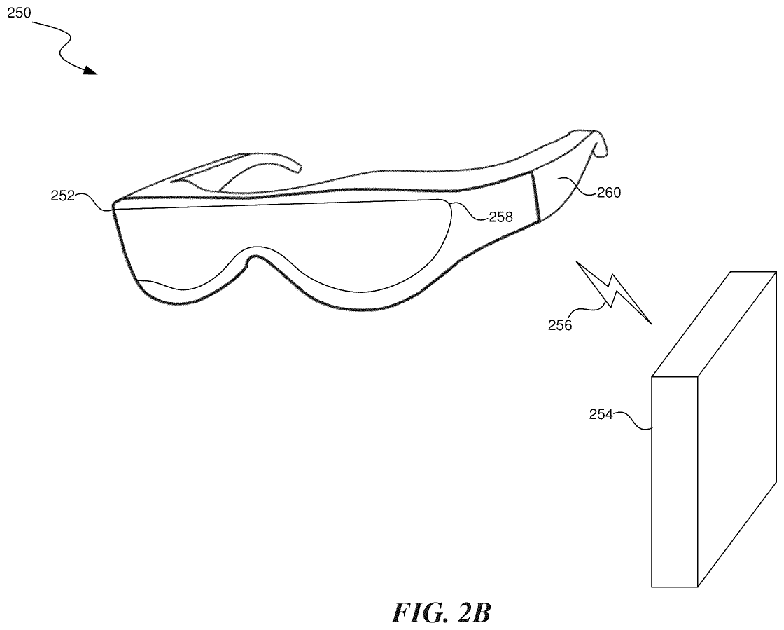

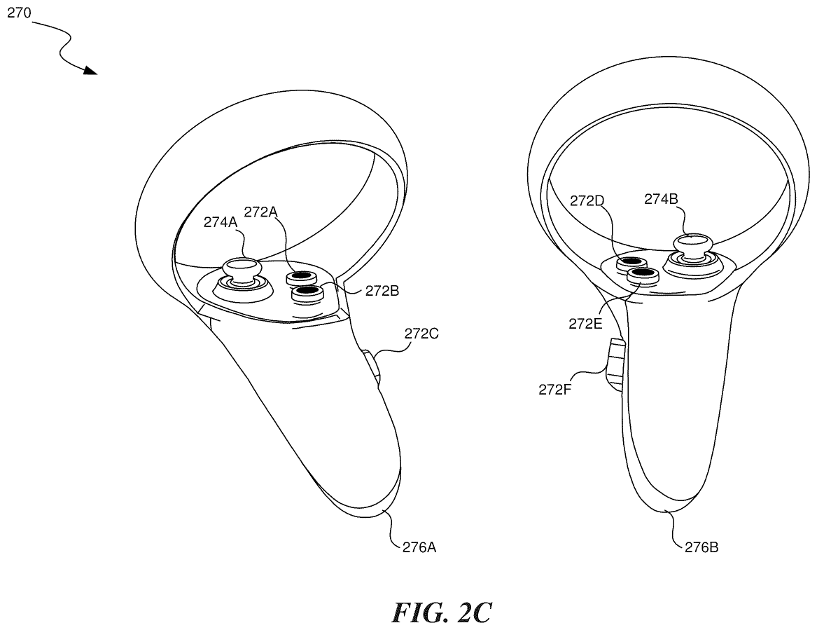

Several implementations are discussed below in more detail in reference to the figures. FIG. 1 is a block diagram illustrating an overview of devices on which some implementations of the disclosed technology can operate. The devices can comprise hardware components of a computing system 100 that mitigates animation disruption for an avatar in an artificial reality (XR) environment. In various implementations, computing system 100 can include a single computing device 103 or multiple computing devices (e.g., computing device 101, computing device 102, and computing device 103) that communicate over wired or wireless channels to distribute processing and share input data. In some implementations, computing system 100 can include a stand-alone headset capable of providing a computer created or augmented experience for a user without the need for external processing or sensors. In other implementations, computing system 100 can include multiple computing devices such as a headset and a core processing component (such as a console, mobile device, or server system) where some processing operations are performed on the headset and others are offloaded to the core processing component. Example headsets are described below in relation to FIGS. 2A and 2B. In some implementations, position and environment data can be gathered only by sensors incorporated in the headset device, while in other implementations one or more of the non-headset computing devices can include sensor components that can track environment or position data.

Computing system 100 can include one or more processor(s) 110 (e.g., central processing units (CPUs), graphical processing units (GPUs), holographic processing units (HPUs), etc.) Processors 110 can be a single processing unit or multiple processing units in a device or distributed across multiple devices (e.g., distributed across two or more of computing devices 101-103).

Computing system 100 can include one or more input devices 120 that provide input to the processors 110, notifying them of actions. The actions can be mediated by a hardware controller that interprets the signals received from the input device and communicates the information to the processors 110 using a communication protocol. Each input device 120 can include, for example, a mouse, a keyboard, a touchscreen, a touchpad, a wearable input device (e.g., a haptics glove, a bracelet, a ring, an earring, a necklace, a watch, etc.), a camera (or other light-based input device, e.g., an infrared sensor), a microphone, or other user input devices.

Processors 110 can be coupled to other hardware devices, for example, with the use of an internal or external bus, such as a PCI bus, SCSI bus, or wireless connection. The processors 110 can communicate with a hardware controller for devices, such as for a display 130. Display 130 can be used to display text and graphics. In some implementations, display 130 includes the input device as part of the display, such as when the input device is a touchscreen or is equipped with an eye direction monitoring system. In some implementations, the display is separate from the input device. Examples of display devices are: an LCD display screen, an LED display screen, a projected, holographic, or augmented reality display (such as a heads-up display device or a head-mounted device), and so on. Other I/O devices 140 can also be coupled to the processor, such as a network chip or card, video chip or card, audio chip or card, USB, firewire or other external device, camera, printer, speakers, CD-ROM drive, DVD drive, disk drive, etc.

In some implementations, input from the I/O devices 140, such as cameras, depth sensors, IMU sensor, GPS units, LiDAR or other time-of-flights sensors, etc. can be used by the computing system 100 to identify and map the physical environment of the user while tracking the user's location within that environment. This simultaneous localization and mapping (SLAM) system can generate maps (e.g., topologies, girds, etc.) for an area (which may be a room, building, outdoor space, etc.) and/or obtain maps previously generated by computing system 100 or another computing system that had mapped the area. The SLAM system can track the user within the area based on factors such as GPS data, matching identified objects and structures to mapped objects and structures, monitoring acceleration and other position changes, etc.

Computing system 100 can include a communication device capable of communicating wirelessly or wire-based with other local computing devices or a network node. The communication device can communicate with another device or a server through a network using, for example, TCP/IP protocols. Computing system 100 can utilize the communication device to distribute operations across multiple network devices.

The processors 110 can have access to a memory 150, which can be contained on one of the computing devices of computing system 100 or can be distributed across of the multiple computing devices of computing system 100 or other external devices. A memory includes one or more hardware devices for volatile or non-volatile storage, and can include both read-only and writable memory. For example, a memory can include one or more of random access memory (RAM), various caches, CPU registers, read-only memory (ROM), and writable non-volatile memory, such as flash memory, hard drives, floppy disks, CDs, DVDs, magnetic storage devices, tape drives, and so forth. A memory is not a propagating signal divorced from underlying hardware; a memory is thus non-transitory. Memory 150 can include program memory 160 that stores programs and software, such as an operating system 162, tracking loss mitigation system 164, and other application programs 166. Memory 150 can also include data memory 170 that can include, e.g., user tracking data, object tracking data, positional rules applicable to a kinematic model of a user, a mapping of contextual characteristics of a user to user states, configuration data, settings, user options or preferences, etc., which can be provided to the program memory 160 or any element of the computing system 100.

Some implementations can be operational with numerous other computing system environments or configurations. Examples of computing systems, environments, and/or configurations that may be suitable for use with the technology include, but are not limited to, XR headsets, personal computers, server computers, handheld or laptop devices, cellular telephones, wearable electronics, gaming consoles, tablet devices, multiprocessor systems, microprocessor-based systems, set-top boxes, programmable consumer electronics, network PCs, minicomputers, mainframe computers, distributed computing environments that include any of the above systems or devices, or the like.

FIG. 2A is a wire diagram of a virtual reality head-mounted display (HMD) 200, in accordance with some embodiments. The HMD 200 includes a front rigid body 205 and a band 210. The front rigid body 205 includes one or more electronic display elements of an electronic display 245, an inertial motion unit (IMU) 215, one or more position sensors 220, locators 225, and one or more compute units 230. The position sensors 220, the IMU 215, and compute units 230 may be internal to the HMD 200 and may not be visible to the user. In various implementations, the IMU 215, position sensors 220, and locators 225 can track movement and location of the HMD 200 in the real world and in an artificial reality environment in three degrees of freedom (3 DoF) or six degrees of freedom (6 DoF). For example, the locators 225 can emit infrared light beams which create light points on real objects around the HMD 200. As another example, the IMU 215 can include e.g., one or more accelerometers, gyroscopes, magnetometers, other non-camera-based position, force, or orientation sensors, or combinations thereof. One or more cameras (not shown) integrated with the HMD 200 can detect the light points. Compute units 230 in the HMD 200 can use the detected light points to extrapolate position and movement of the HMD 200 as well as to identify the shape and position of the real objects surrounding the HMD 200.

The electronic display 245 can be integrated with the front rigid body 205 and can provide image light to a user as dictated by the compute units 230. In various embodiments, the electronic display 245 can be a single electronic display or multiple electronic displays (e.g., a display for each user eye). Examples of the electronic display 245 include: a liquid crystal display (LCD), an organic light-emitting diode (OLED) display, an active-matrix organic light-emitting diode display (AMOLED), a display including one or more quantum dot light-emitting diode (QOLED) sub-pixels, a projector unit (e.g., microLED, LASER, etc.), some other display, or some combination thereof.

In some implementations, the HMD 200 can be coupled to a core processing component such as a personal computer (PC) (not shown) and/or one or more external sensors (not shown). The external sensors can monitor the HMD 200 (e.g., via light emitted from the HMD 200) which the PC can use, in combination with output from the IMU 215 and position sensors 220, to determine the location and movement of the HMD 200.

FIG. 2B is a wire diagram of a mixed reality HMD system 250 which includes a mixed reality HMD 252 and a core processing component 254. The mixed reality HMD 252 and the core processing component 254 can communicate via a wireless connection (e.g., a 60 GHz link) as indicated by link 256. In other implementations, the mixed reality system 250 includes a headset only, without an external compute device or includes other wired or wireless connections between the mixed reality HMD 252 and the core processing component 254. The mixed reality HMD 252 includes a pass-through display 258 and a frame 260. The frame 260 can house various electronic components (not shown) such as light projectors (e.g., LASERs, LEDs, etc.), cameras, eye-tracking sensors, MEMS components, networking components, etc.

The projectors can be coupled to the pass-through display 258, e.g., via optical elements, to display media to a user. The optical elements can include one or more waveguide assemblies, reflectors, lenses, mirrors, collimators, gratings, etc., for directing light from the projectors to a user's eye. Image data can be transmitted from the core processing component 254 via link 256 to HMD 252. Controllers in the HMD 252 can convert the image data into light pulses from the projectors, which can be transmitted via the optical elements as output light to the user's eye. The output light can mix with light that passes through the display 258, allowing the output light to present virtual objects that appear as if they exist in the real world.

Similarly to the HMD 200, the HMD system 250 can also include motion and position tracking units, cameras, light sources, etc., which allow the HMD system 250 to, e.g., track itself in 3 DoF or 6 DoF, track portions of the user (e.g., hands, feet, head, or other body parts), map virtual objects to appear as stationary as the HMD 252 moves, and have virtual objects react to gestures and other real-world objects.

FIG. 2C illustrates controllers 270 (including controller 276A and 276B), which, in some implementations, a user can hold in one or both hands to interact with an artificial reality environment presented by the HMD 200 and/or HMD 250. The controllers 270 can be in communication with the HMDs, either directly or via an external device (e.g., core processing component 254). The controllers can have their own IMU units, position sensors, and/or can emit further light points. The HMD 200 or 250, external sensors, or sensors in the controllers can track these controller light points to determine the controller positions and/or orientations (e.g., to track the controllers in 3 DoF or 6 DoF). The compute units 230 in the HMD 200 or the core processing component 254 can use this tracking, in combination with IMU and position output, to monitor hand positions and motions of the user. The controllers can also include various buttons (e.g., buttons 272A-F) and/or joysticks (e.g., joysticks 274A-B), which a user can actuate to provide input and interact with objects.

In various implementations, the HMD 200 or 250 can also include additional subsystems, such as an eye tracking unit, an audio system, various network components, etc., to monitor indications of user interactions and intentions. For example, in some implementations, instead of or in addition to controllers, one or more cameras included in the HMD 200 or 250, or from external cameras, can monitor the positions and poses of the user's hands to determine gestures and other hand and body motions. As another example, one or more light sources can illuminate either or both of the user's eyes and the HMD 200 or 250 can use eye-facing cameras to capture a reflection of this light to determine eye position (e.g., based on set of reflections around the user's cornea), modeling the user's eye and determining a gaze direction.

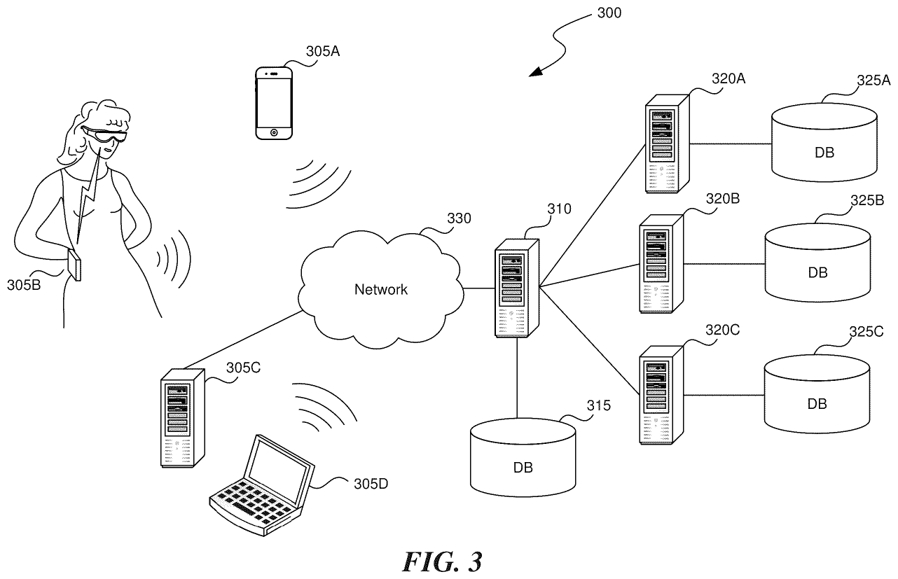

FIG. 3 is a block diagram illustrating an overview of an environment 300 in which some implementations of the disclosed technology can operate. Environment 300 can include one or more client computing devices 305A-D, examples of which can include computing system 100. In some implementations, some of the client computing devices (e.g., client computing device 305B) can be the HMD 200 or the HMD system 250. Client computing devices 305 can operate in a networked environment using logical connections through network 330 to one or more remote computers, such as a server computing device.

In some implementations, server 310 can be an edge server which receives client requests and coordinates fulfillment of those requests through other servers, such as servers 320A-C. Server computing devices 310 and 320 can comprise computing systems, such as computing system 100. Though each server computing device 310 and 320 is displayed logically as a single server, server computing devices can each be a distributed computing environment encompassing multiple computing devices located at the same or at geographically disparate physical locations.

Client computing devices 305 and server computing devices 310 and 320 can each act as a server or client to other server/client device(s). Server 310 can connect to a database 315. Servers 320A-C can each connect to a corresponding database 325A-C. As discussed above, each server 310 or 320 can correspond to a group of servers, and each of these servers can share a database or can have their own database. Though databases 315 and 325 are displayed logically as single units, databases 315 and 325 can each be a distributed computing environment encompassing multiple computing devices, can be located within their corresponding server, or can be located at the same or at geographically disparate physical locations.

Network 330 can be a local area network (LAN), a wide area network (WAN), a mesh network, a hybrid network, or other wired or wireless networks. Network 330 may be the Internet or some other public or private network. Client computing devices 305 can be connected to network 330 through a network interface, such as by wired or wireless communication. While the connections between server 310 and servers 320 are shown as separate connections, these connections can be any kind of local, wide area, wired, or wireless network, including network 330 or a separate public or private network.

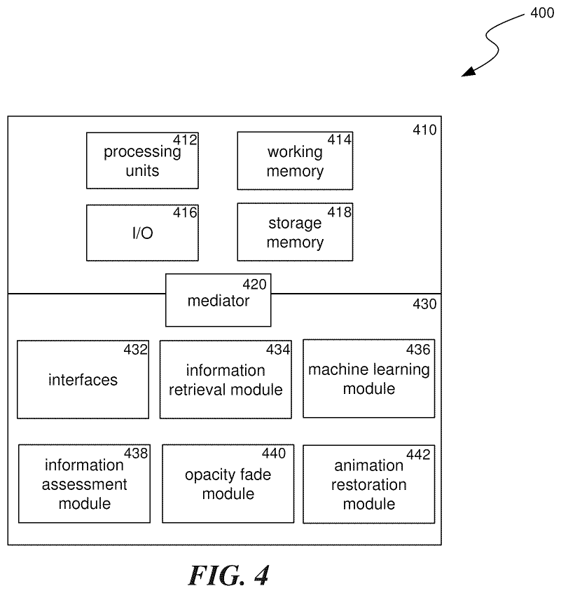

FIG. 4 is a block diagram illustrating components 400 which, in some implementations, can be used in a system employing the disclosed technology. Components 400 can be included in one device of computing system 100 or can be distributed across multiple of the devices of computing system 100. The components 400 include hardware 410, mediator 420, and specialized components 430. As discussed above, a system implementing the disclosed technology can use various hardware including processing units 412, working memory 414, input and output devices 416 (e.g., cameras, displays, IMU units, network connections, etc.), and storage memory 418. In various implementations, storage memory 418 can be one or more of: local devices, interfaces to remote storage devices, or combinations thereof. For example, storage memory 418 can be one or more hard drives or flash drives accessible through a system bus or can be a cloud storage provider (such as in storage 315 or 325) or other network storage accessible via one or more communications networks. In various implementations, components 400 can be implemented in a client computing device such as client computing devices 305 or on a server computing device, such as server computing device 310 or 320.

Mediator 420 can include components which mediate resources between hardware 410 and specialized components 430. For example, mediator 420 can include an operating system, services, drivers, a basic input output system (BIOS), controller circuits, or other hardware or software systems.

Specialized components 430 can include software or hardware configured to perform operations for mitigating animation disruption in an XR environment by establishing an avatar rest pose from which to reinitiate animation for an avatar. Specialized components 430 can include an information retrieval module 434, a machine learning module 436, an information assessment module 438, an opacity fade module 440, an animation restoration module 442, and components and APIs which can be used for providing user interfaces, transferring data, and controlling the specialized components, such as interfaces 432. In some implementations, components 400 can be in a computing system that is distributed across multiple computing devices or can be an interface to a server-based application executing one or more of specialized components 430. Although depicted as separate components, specialized components 430 may be logical or other nonphysical differentiations of functions and/or may be submodules or code-blocks of one or more applications.

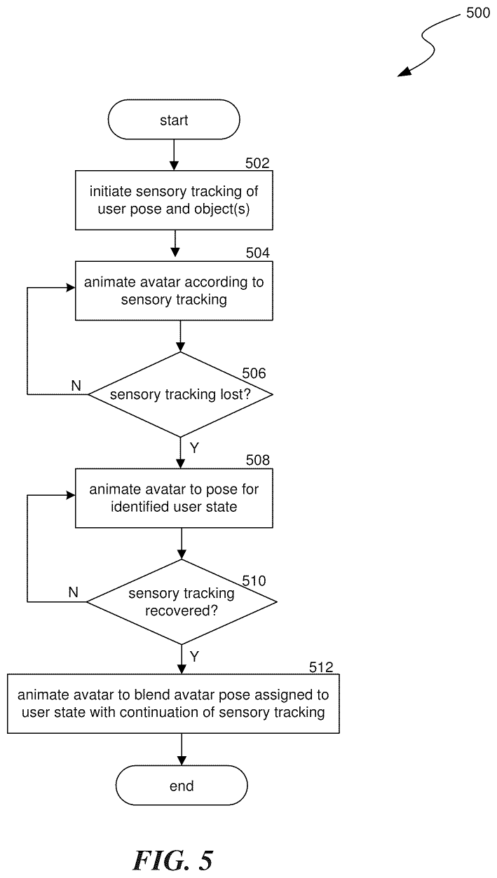

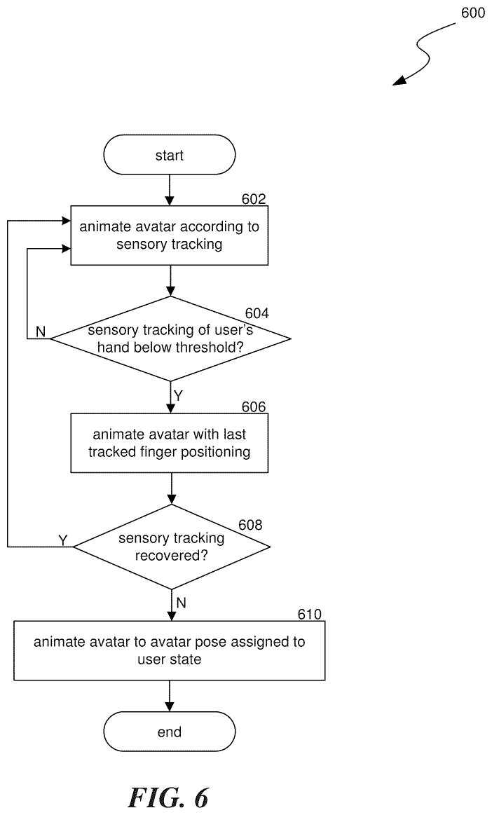

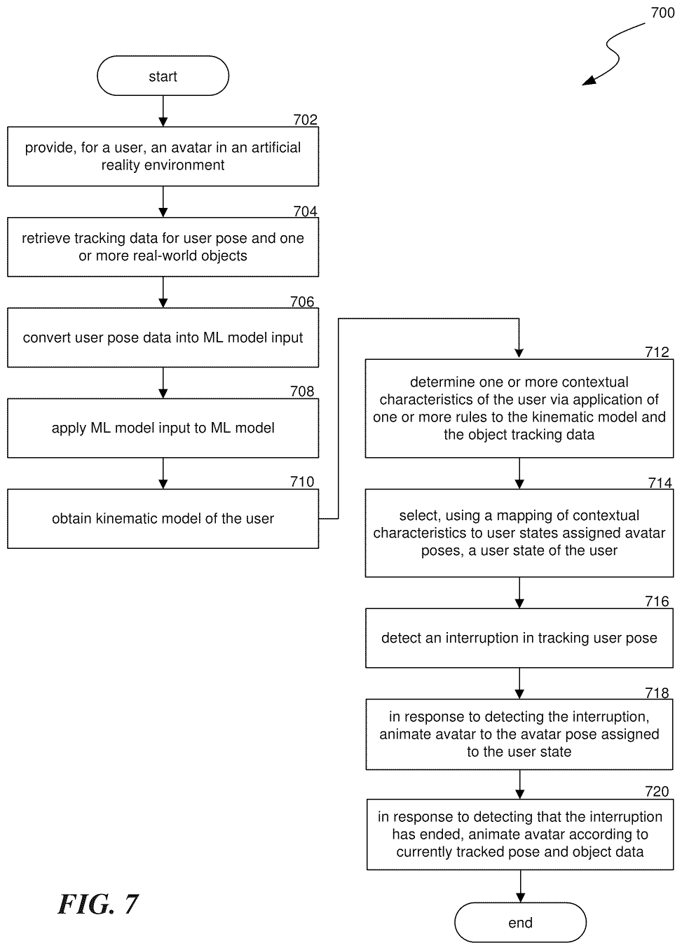

In some implementations, information retrieval module 434 can retrieve tracking data for a user's pose and tracking data for one or more real-world objects in a vicinity of the user. For instance, information retrieval module 434 can retrieve the tracking data for a user's pose from an XR device headset (e.g., headset 252), where, for instance, such a headset can include an inertial motion unit (IMU) to provide a movement profile of a user of the headset 252. Information retrieval module 434 can further retrieve user pose data in the form of images or depth data that can be obtained from an imaging device implemented by, for example, core processing component 254 that can be in communication with the XR device headset 252. Accordingly, information retrieval module 434 can retrieve data that can indicate tracking for a user's pose with respect to whether that tracking has initiated, been interrupted, and/or has reinitiated. Additional details on the types of data that can be retrieved by information retrieval module 434 are provided below in relation to blocks 502, 506, and 510 of FIG. 5; blocks 602, 604, 606, and 608 of FIG. 6, and blocks 704 and 716 of FIG. 7.

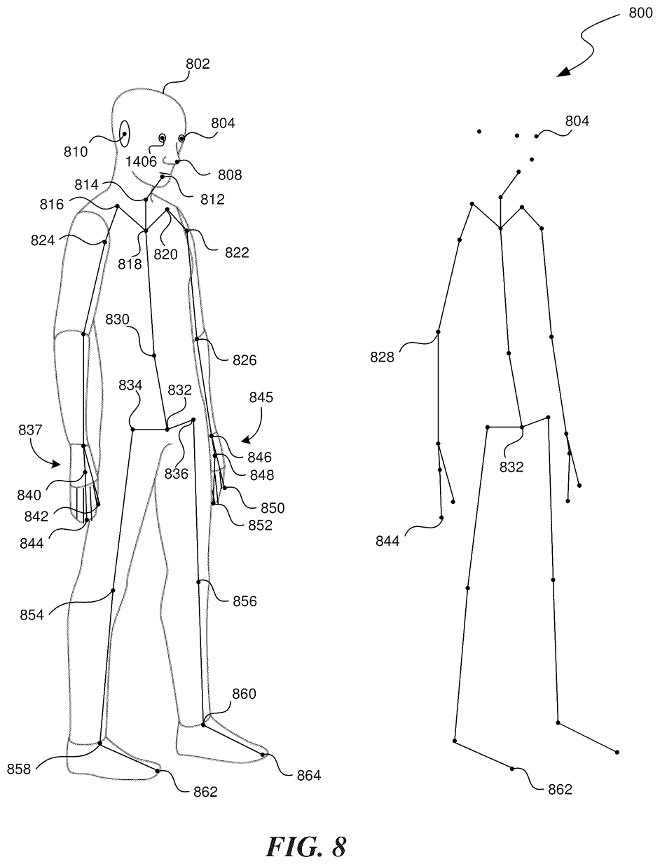

In some implementations, machine learning module 436 can intake user pose data retrieved by information retrieval module 434 to generate a kinematic model, which is sometimes referred to as a body model, for the user. As mentioned above, the kinematic model can specify a current body configuration of the user, e.g., distances between body points, such as the distance between the wrist and elbow joints, and angles between body parts, such as the angle between the forearm and upper arm or the direction of the head in relation to the shoulders. An example kinematic model is discussed below in relation to FIG. 8. In various implementations, one or more machine learning models can be trained to generate the kinematic model. In some implementations, this/these model(s) can be trained using synthetic images of people in various environments and characteristics, generated with known depth data and body positions. Additional details regarding generation of the kinematic model of the user by machine learning module 436 are provided below in relation to block 508 of FIG. 5, block 610 of FIG. 6, and blocks 706, 708, and 710 of FIG. 7.

In some implementations, information assessment module 438 can assess data retrieved by information retrieval module 434 and the kinematic model generated by machine learning module 436 for guiding various operations of tracking loss mitigation system 164. For instance, information assessment module 438 can assess whether sensory tracking of user pose has initiated, been interrupted, or has been reinitiated. Still further, information assessment module 438 can assess, using the user pose data retrieved by information retrieval module 434, one or more positional rules that ought to be applied to the kinematic model generated by machine learning module 436 and the retrieved object data. This way, information assessment module 438 can determine one or more contextual characteristics of the user that it can use to identify a user state assigned to an avatar pose. In this regard, the one or more contextual characteristics can, for instance, define placement of one or more body parts, e.g., a user's hand or hands, with respect to one or more real-world objects disposed in a vicinity of the user while interacting with an XR environment. For example, information assessment module 438 can make that identification from among a mapping of contextual characteristics to user states, where the user states can define a static or dynamic configuration of one or more portions of the user's body compared to another body portion and/or the one or more real-world objects. Additional details on the types of assessments of information that can be performed by information assessment module 438 are provided below in relation to blocks 504, 506, 508, and 510 of FIG. 5; blocks 602, 604, 606, and 608 of FIG. 6; and blocks 712, 714, and 716 of FIG. 7.

In some implementations, opacity fade module 440 can decrease the opacity of an avatar representing a user in an XR environment for which tracking of a user's pose for that environment has been lost, either completely or partially. For instance, opacity fade module 440 can fade the opacity of one or more portions of the avatar by a predetermined percentage in response to the machine learning module 438 not being able to confidently generate the kinematic model of one or portions of the user. This way, as the one or more portions of the avatar experience an increased level of transparency, such transparency can serve as an indication (i.e., notification) to the user that tracking for the user's pose has been lost. For instance, in the case of a complete loss of tracking, the tracking loss mitigation system 164 can fade opacity to, for instance, 80%, as opposed to a case of partial loss where the fade can be reduced, for example, to 60%. In some implementations, other indicators can be used such as change in color, change to type of drawing, change to shading, ect. Additional details on operations of opacity fade module 440 are provided below in relation to block 506 of FIG. 5, block 604 of FIG. 6, and block 716 of FIG. 7.

In some implementations, animation restoration module 442 can restore animation of an avatar representing a user for whom tracked pose has been lost. That is, animation restoration module 442 can restore animation from an avatar rest pose discussed above in relation to information assessment module 438. For instance, animation module 442 can communicate with information retrieval module 434 to recognize that tracking of user's pose has been sufficiently regained such that a current tracking state is appropriate for animating an avatar corresponding to the user. Resultingly, animation restoration module 442 can then blend the avatar rest pose with currently received user pose data to further seamlessly animate the avatar. Conversely, animation restoration module 442 can determine that restoration of animation to the avatar is inappropriate, whereby the module can maintain the user state identified by information assessment module 438. Additional details on restoring animation are provided below in relation to block 512 of FIG. 5, block 610 of FIG. 6, and block 718 of FIG. 7.

Those skilled in the art will appreciate that the components illustrated in FIGS. 1-4 described above, and in each of the flow diagrams discussed below, may be altered in a variety of ways. For example, the order of the logic may be rearranged, substeps may be performed in parallel, illustrated logic may be omitted, other logic may be included, etc. In some implementations, one or more of the components described above can execute one or more of the processes described below.

FIG. 5 is a flow diagram illustrating a process 500 used in some implementations of the present technology for animating an avatar in response to tracking of a user's pose being interrupted. Herein, either a complete or partial interruption in tracking a user's pose can be the result of sensors for tracking loss mitigation system 164 (e.g., sensors disposed with headset 252) being obstructed from viewing, respectively, an entirety or part of a user's hand or hands. In some implementations, process 500 can be initiated by a user executing a program to create an XR environment. In some implementations, process 500 can be performed on a server system in control of that XR environment; while in some cases all or parts of process 500 can be performed on an XR client device.

At block 502, process 500 can initiate sensory tracking of a user's pose (i.e., motion and/or position of the user) and objects in a vicinity of the user. Process 500 can interpret obtained data to animate an avatar that can represent the user in an XR environment. For instance, user pose data according to the tracking can be generated from IMU data, image data, and/or depth data obtained from the headset 252 or processing device 254, and the object data can be image data of a real-world environment surrounding a user while wearing the headset 252. For instance, the image data can be produced by one or more cameras implemented according to core processing component 254. Throughout the tracking, process 500 can log the types of data received as well as when that data was received in order to coordinate animation of the user's avatar in the XR environment.

At block 504, process 500 can animate the avatar according to the sensory tracking data. That is, process 500 can align the pose tracked for the user with a pose for the user's avatar in the XR environment, whereby aspects of the user's motion and/or position are translated to the avatar. For example, process 500 can map the tracking data to a kinematic model for the user, which can be used to control corresponding points on an avatar in the artificial reality environment.

At block 506, process 500 can determine whether sensory tracking for the user's pose has been lost. In other words, process 500 can determine the loss according to whether an amount of received tracking data is sufficient or inadequate to obtain a kinematic model of the user. To do so, process 500 can evaluate whether the amount of the received tracking data meets or exceeds a predetermined threshold, where the threshold can be a percentage of tracking data that must be received to generate the kinematic model of the user. By way of example, if only 60% of received tracking data can be used to generate a kinematic model of a user's hand or hands and the predetermined threshold is 70%, then process 500 can determine that sensory tracking for the user's pose has been completely lost. In some cases, a confidence factor produced by the machine learning model that generates the kinematic model can be the factor compared to the threshold to determine whether the tracking data is sufficient. In a case where the tracking data is insufficient, process 500 can indicate the loss to the user through an opacity fading of, for example, the affected hand and arm of the user's avatar, by fading part of the avatar to black and white, by animating part of the avatar in a different style, etc. For example, process 500 can implement the fading to a 95% extent (i.e., 5% opaqueness). Otherwise, i.e., in a case in which sensory tracking for the user's pose has not been lost (e.g., an amount of tracking data has been maintained at or above the predetermined threshold), process 500 can return to block 504 to continue to animate the user's avatar in the normal course.

However, in a case where process 500 had identified that the predetermined threshold for received tracking data has not been satisfied, process 500 can proceed to block 508. At block 508, process 500 can animate the user's avatar to a rest pose corresponding to the user's state at the time of the tracking interruption. In this regard, the user's state can define a static or dynamic configuration of one or more portions of the user's body compared to another body portion and/or the one or more real-world objects. As is discussed with reference to FIG. 7, such a user state can be derived from one or more contextual characteristics of the user, where such characteristics can correspond to placement of one or more body parts of the user. In some implementations, such placement can be defined with respect to one or more real-world objects whose position process 500 can track. For instance, process 500 can determine, for an XR environment replicating an office setting, contextual characteristics defining which portions of the user's body are or are not placed on a worktop for the office. Using these characteristics, process 500 can then determine an applicable user state, such as whether the user is seated at the worktop, standing away from the worktop, etc., as explained in more detail below with reference to FIG. 7.

At block 510, process 500 can determine whether sensory tracking for the user's pose and objects in a vicinity of the user has been regained. If not, process 500 can return to block 508, where it can continue to animate the user's avatar at the above-discussed user state.

In a case in which sensory tracking has been regained, process 500 can proceed to block 512. There, process 500 can animate the user's avatar to blend the avatar's rest pose for the identified user state with animation corresponding to a continuation of the sensory tracking. This way, process 500 can integrate animation corresponding to a time of interrupted sensory tracking with a current tracking for the user's pose.

FIG. 6 is a flow diagram illustrating a process 600 used in some implementations of the present technology for animating an avatar in response to tracking of a user's pose being partially interrupted. Process 600 can be initiated during interactions of a user for an XR environment, and can be performed on a server system in control of an XR application for that XR environment or on an XR client device operating the selected XR application. In some implementations, process 600 can be performed as a sub-process of process 500 of FIG. 5, e.g., at block 506. For instance and where the user's pose can be evaluated according to one or more contextual characteristics detailing placement of the user's hand, animation for such pose can be considered to be partially interrupted if tracking data for the user's hand falls below a predetermined threshold amount. In other words, the partial interruption can occur when an amount of the tracking data necessary to generate a kinematic model of finger poses for a user's hand is insufficient.

At block 602, process 600 can animate a user's avatar according to sensory tracking for the user's pose. In some cases, process 600 can map the tracking data to a kinematic model for the user, which can be used to control corresponding points on an avatar in the artificial reality environment. For example, process 600 can implement received tracking data to animate a hand of the user's avatar, including finger poses.

At block 604, process 600 can determine whether sensory tracking for the user's hand has fallen below a predetermined threshold, i.e., an amount of received tracking data that can be sufficient to generate a kinematic model for an entirety of the user's hand, where amounts of the data are apportioned for the fingers and remaining parts of the hand. That is, process 600 can determine, by way of example, that a confidence value for the tracking data (e.g., produced by a machine learning model trained to analyze the tracking data and map it to a kinematic model) in an amount falling within a predetermined threshold range of between 70-80% can indicate that tracking for the user's fingers has been lost (e.g., due to obstruction in sensory perception by the user's XR headset). Where an amount of tracking data is maintained above the predetermined threshold range, process 600 can return to block 602 to continue to animate the avatar in the normal course.

However, in a case in which the amount of received tracking data falls within the predetermined threshold range, process 600 can proceed to block 606. There, process 600 can animate portions of the avatar's hand, excluding its fingers, according to received tracking data, where the fingers can be paused in their last known position (i.e., the position tracked prior to the predetermined threshold range being met). In other words, process 600 can continue to animate the avatar's hand position, but with the fingers locked into the positions where they were previously tracked prior to loss of finger tracking accuracy. At this time, process 600 can indicate loss of the finger tracking to the user by, for example, fading the opacity of the avatar's arm and hand by 60% (i.e., 40% opaqueness).

At block 608, process 600 can determine whether sensory tracking for the user's pose and objects in a vicinity of the user has been regained. If so, process 600 can return to block 602 where the user's avatar can be animated according to currently received tracking data. For instance, the avatar's hand can be animated to blend the paused finger positioning according to the currently received tracking data.

In some implementations, process 600 can recognize further diminishment in amounts of received tracking data such that a kinematic model for the user's hand cannot support continued animation. In this case, process 600 can pause animation for the avatar's overall hand pose (i.e., the hand pose including the last known finger positioning) for a predetermined period of time prior to, at block 610, animating the avatar to the rest pose (i.e., the avatar pose assigned to a user state) as discussed with reference to block 506 of FIG. 5. Process 600 can indicate the pause to the user by fading the opacity of the avatar's hand and arm to, for example, 20%. Thus, as will be understood, processes 500 and 600 provide a user an opportunity to be informed about disruptions in animation for an XR environment at various stages which are commensurate with extents of losses in tracking for the user's pose. Accordingly, the user can proceed knowledgeably with respect to interactions for the XR environment until such time as tracking for the user's pose is regained.

FIG. 7 is a flow diagram illustrating a process 700 used in some implementations of the present technology for selecting an avatar pose to which an avatar can be animated following detection of an interruption in tracking of a user's pose. Process 700 can be initiated when a user engages in interactions for an XR environment. Process 700 can be performed on a server that can provide XR applications for that environment, or on an XR client device operating a selected one of those XR applications.

At block 702, process 700 can provide, for a user, an avatar in an XR environment. In this regard, the avatar can be selected by the user according to selections made available by an XR application for the XR environment. In some implementations, the avatar can be automatically provided by the XR application.

At block 704, process 700 can retrieve tracking data for a user's pose and one or more real-world objects. In these regards, the tracking data for user pose can be accumulated, for instance, by an XR headset of the user, and the tracking data for the one or more real-world objects can be gathered by one or more imaging devices integrated with or in communication with the headset.

At block 706, process 700 can convert the retrieved user pose data into machine learning model input. For example, images from the headset data and the object data can be converted into a histogram or other numerical data that the machine learning model has been trained to receive.

At block 708, process 700 can apply the input to a machine learning model. A “machine learning model” or “model” as used herein, refers to a construct that is trained using training data to make predictions or provide probabilities for new data items, whether or not the new data items were included in the training data. For example, training data for supervised learning can include positive and negative items with various parameters and an assigned classification. Examples of models include: neural networks (traditional, deeps, convolution neural network (CSS), recurrent neural network (RNN)), support vector machines, decision trees, decision tree forests, Parzen windows, Bayes, clustering, reinforcement learning, probability distributions, decision trees, and others. Models can be configured for various situations, data types, sources, and output formats.

The machine learning model can be trained with supervised learning and use training data that can be obtained from synthetic images of people in various environments and characteristics, generated with known depth data, and body positions. More specifically, each item of the training data can include an instance of a body part matched to a particular positioning. The matching can be performed according to known relationships for body parts in various states (e.g., closed palm, bent knee, curled finger, etc.). During the model training a representation of the user pose data (e.g., histograms of the images, values representing the headset data, etc.) can be provided to the model. Then, the output from the model, i.e., a kinematic model of the user, can be compared to the actual user pose data and, based on the comparison, the model can be modified, such as by changing weights between nodes of the neural network or parameters of the functions used at each node in the neural network (e.g., applying a loss function). After applying each of the pairings of the inputs (user pose data) and the desired output (a kinematic model of the user) in the training data and modifying the model in this manner, the model is trained to evaluate new instances of user pose data in order to determine various poses for the user.

At block 712, process 700 can determine one or more contextual characteristics of the user that can correspond to a placement of one or more portions of the user's body. In this regard, the placements can be relative to solely the user's body or the user's body with respect to one or more real-world objects (e.g., a worktop in an office environment). For instance, process 700 can determine the placements by applying one or more positional rules to the kinematic model obtained at block 710 and the object tracking data retrieved at block 704. The positional rules can, for example, be implemented by process 700 as directives yielding positioning for portions of the user's body, where that positioning can be further relative to a real-world object. For example, such a positional rule can state that, for the tracked user pose and object data, “a user's hand is on worktop if a distance between the worktop and one or more of the user's hands is zero,” where the corresponding contextual characteristic of the user is, “hand on worktop.” Another example of a positional rule that process 700 can implement can state that, “a user's hand and elbow are on the worktop if an angle between the hand and the elbow is zero and a distance between the user's hand and elbow to the worktop is zero,” where the corresponding contextual characteristic of the user is, “elbow and hand on worktop.” Still another positional rule that process 700 can implement can state that, “a user's hand is in her lap if her hand is disposed at a zero distance from an area between the user's waist to her knees when in a sitting position,” where the corresponding contextual characteristic of the user is, “hand is in lap.” Yet another positional rule can state that, “a user's hands are by her sides if her hands are parallel with her legs,” where the corresponding contextual characteristic of the user is, “hands by side.” Accordingly, process 700 can define a contextual characteristic of the user according to the determined relative positioning of the user, where the contextual characteristic can respectively specify a disposition of the user's hand or hands with respect to remaining portions of the user's body and/or with respect to a real-world object such as the worktop in the above-discussed example. For example, the contextual characteristic can be that the user is facing the worktop or turned away from it. It can be understood that, through application of others of positional rules that can be applied to the kinematic model, process 700 can determine other contextual characteristics of the user.

At block 714, process 700 can select, using a mapping of contextual characteristics to user states assigned avatar poses, a user state of the user. For instance, the mapping can be in tabular form, where a contextual characteristic corresponds to a user state assigned to an avatar pose. This way, process 700 can make the selection of the user state corresponding to the contextual characteristic(s) determined at block 712. As has been discussed above, a user state can correspond to a static or dynamic configuration of one or more portions of the user's body compared to another body portion and/or the one or more real-world objects. Thus, contextual characteristic—user state pairings for the contextual characteristics discussed above can be as follows: “hand on worktop—user is at worktop,” “elbow and hand on worktop—user is at worktop and facing to one side,” “hand in lap—user is seated at a distance from worktop,” and “hands by side—user is standing away from worktop.” For the user states, corresponding avatar rest poses can be, respectively, “avatar's hands placed on worktop,” “avatar is at worktop and facing to one side,” “avatar is seated at a distance from worktop,” and “avatar is standing away from worktop.”

At block 716, process 700 can determine whether an interruption in tracking of a user's pose has occurred. For example, process 700 can make such a determination in response to an inability to generate the kinematic model of the user with regard to one or more portions, or the entirety, of a user's hand. Correspondingly, therefore, process 700 can determine that a partial or complete interruption in tracking has occurred. As has been discussed, the extent (i.e., partial or complete) of the interruption can be evaluated by tracking loss mitigation system 164 according to an amount of tracking data received for generating the kinematic model of the user. Thus, as a result of the evaluation, process 700 can further assess whether to implement opacity fading with respect to the user's affected hand and arm in order to indicate to the user that an interruption in tracking is being experienced.

At block 718, process 700 can, in response to detecting the interruption at block 716, animate the user's avatar to the avatar pose assigned to the user state selected at block 714. As discussed, the assigned avatar pose can be a rest pose from which animation for the user's avatar can be reinitiated as a result of regaining tracking for the user's pose. This way, tracking loss mitigation system 164 can, via opacity fading for the affected hand hands and arm/arms of the avatar for indicating an interruption in tracking to the user, mitigate disruption in animation for that avatar. That is, tracking loss mitigation system 164 can, by providing the indication to the user and animating the avatar to its rest pose, avoid missing user interactions for an artificial reality environment.

At block 720, process 700 can, in response to detecting that the interruption in tracking of the user's pose has ended, animate the user's avatar to match a pose according to currently tracked user and object data. For instance, process 700 can undertake such animation as a result of process 700 evaluating that a sufficient amount of sensory tracking data for the user's pose has been received to generate a kinematic model of the user.

FIG. 8 is a conceptual diagram illustrating an example 800 of a kinematic model of a user. On the left side, example 800 illustrates points defined on a body of a user 802 while these points are again shown on the right side of FIG. 8 without the corresponding person to illustrate the actual components of the kinematic model. These points include eyes 804 and 806, nose 808, ears 810 (second ear point not shown), chin 812, neck 814, clavicles 816 and 820, sternum 818, shoulders 822 and 824, elbows 826 and 828, stomach 830, pelvis 832, hips 834 and 836, hands 837 and 845, wrists 838 and 846, palms 840 and 848, thumb tips 842 and 850, finger tips 844 and 852, knees 854 and 856, ankles 858 and 860, and tips of feet 862 and 864. In various implementations, more or less points are used in the kinematic model. Some corresponding labels have been put on the points on the right side of FIG. 8, but some have been omitted to maintain clarity. Points connected by lines show that the kinematic model maintains measurements of distances and angles between certain points. Because points 804-810 are generally fixed relative to point 812, they do not need additional connections.

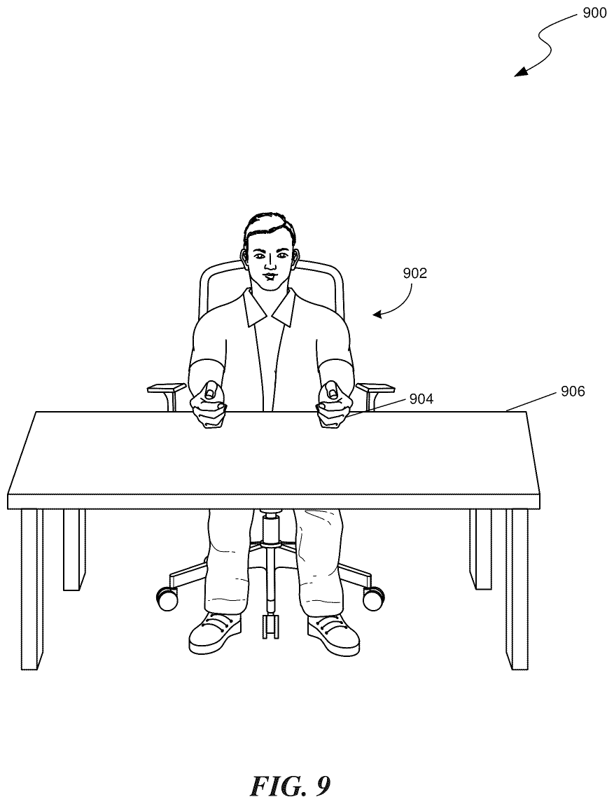

FIG. 9 is a conceptual diagram 900 illustrating, according to implementations of the present technology, an avatar 902 having a rest pose matching a first user state identified for a user following an interruption in tracking of the user's pose. In this regard, tracking loss mitigation system 164 can, for an artificial reality environment mirroring a user environment, identify the first user state of, “user is at worktop,” according to the above-discussed mapping for contextual characteristics to user states, where the corresponding contextual characteristic of the user is, “hand on worktop.” To recall, tracking loss mitigation system 164 can obtain that contextual characteristic via application of the positional rule, “a user's hand in on worktop if a distance between the worktop and one or more of the user's hands is zero,” to the kinematic model of the user and tracking data for a worktop in the vicinity of the user. Accordingly, tracking loss mitigation system 164 can, in response to tracking of the user's pose being interrupted, animate the user's avatar to a rest pose matching the user state by positioning the avatar's hands 904 on the worktop 906.

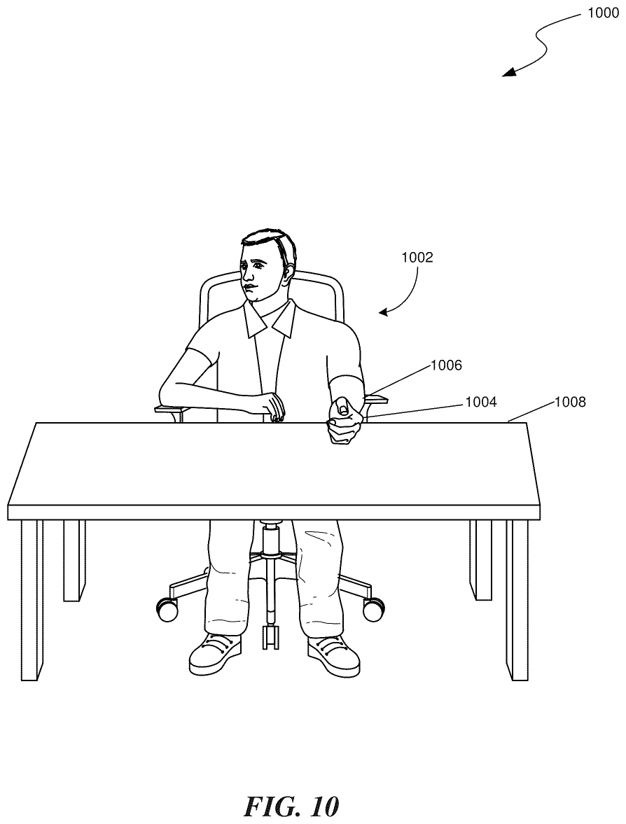

FIG. 10 is a conceptual diagram illustrating, according to implementations of the present technology, an avatar 1002 having a rest pose matching a second user state identified for a user following an interruption in tracking of the user's pose. Similarly as in FIG. 9, tracking loss mitigation system 164 can identify this second user state according to a mapping of contextual characteristics to user states. Here, the second user state is, “user is at worktop and facing to one side,” where the corresponding contextual characteristic for the mapping is, “elbow and hand on worktop.” As discussed, such characteristic can be obtained by tracking loss mitigation system 164 according to its application of the positional rule, “a user's hand and elbow are on the worktop if an angle between the hand and the elbow is zero and a distance between the user's hand, elbow and worktop is zero,” to the kinematic model of the user and tracking data for a worktop in the vicinity of the user. This way, tracking loss mitigation system 164 can animate the user's avatar to a rest pose matching the user state by orienting the avatar's hand 1004 and elbow 1006 to be disposed on the worktop 1008.

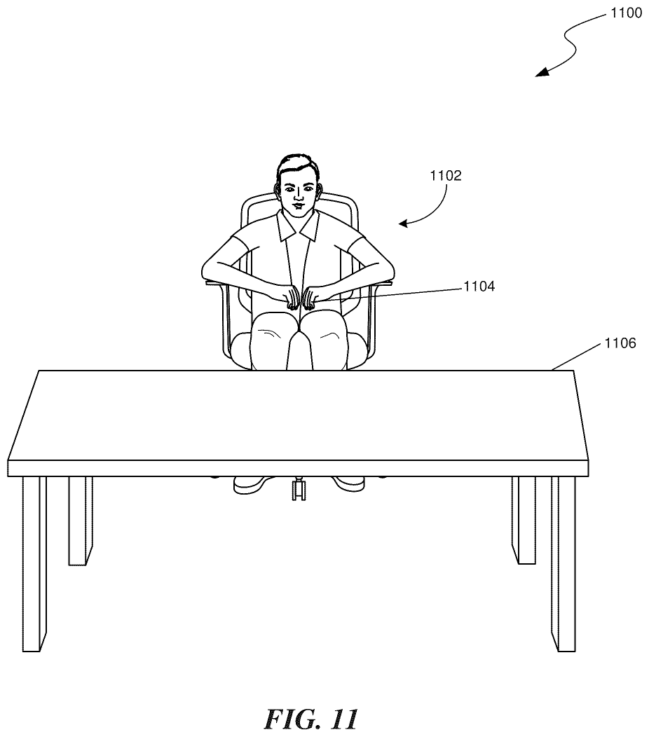

FIG. 11 is a conceptual diagram illustrating, according to implementations of the present technology, an avatar 1102 having a rest pose matching a third user state (i.e., “user is seated at a distance from worktop”) identified for a user following an interruption in tracking of a user's pose. Tracking loss mitigation system 164 can, for the contextual characteristic of a user of, “hand in lap,” and from a mapping of contextual characteristics to user states, identify the third user state as being applicable for the user's pose in relation to a worktop in the vicinity of the user. For instance, tracking loss mitigation system 164 can determine such contextual characteristic by applying the positional rule, “a user's hand is in her lap if her hand is disposed at a zero distance from an area between the user's waist to her knees when in a sitting position,” to the kinematic model of the user discussed in relation to FIG. 8 and tracking data received for a worktop in a vicinity of the user. In this way, tracking loss mitigation system 164 can animate the user's avatar 1102 to locate at least one of its hands 1104 in the avatar's lap, such that the user's avatar 1102 is distanced from the worktop 1106.

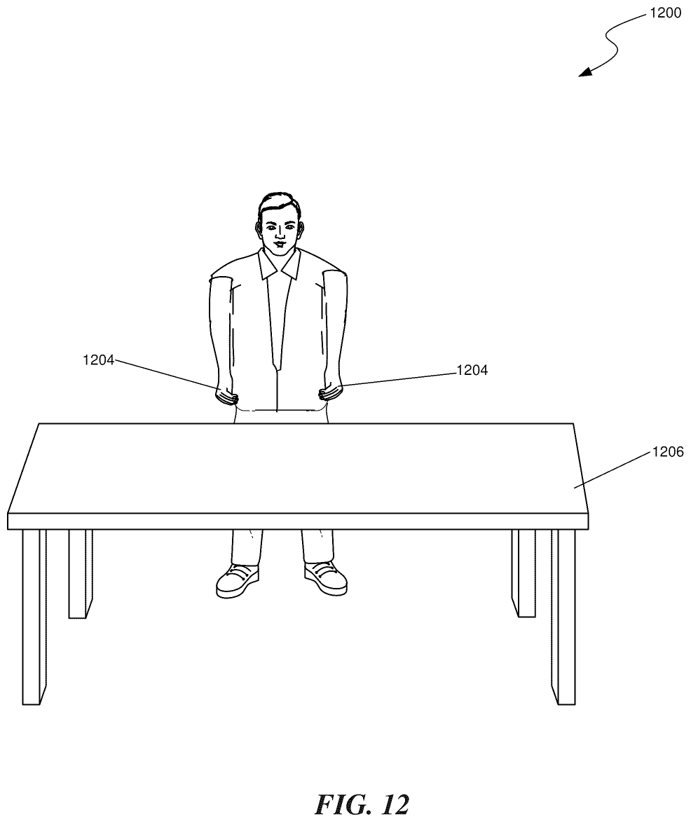

FIG. 12 is a conceptual diagram illustrating, according to implementations of the present technology, an avatar 1202 having a rest pose matching a fourth user state identified for a user following an interruption in tracking of a user's pose. As is shown, the fourth user state is, “user is standing away from worktop.” Similarly as in FIGS. 9-11, tracking loss mitigation system 164 can determine such a user state from an application of a positional rule (i.e, “a user's hands are by her sides if her hands are parallel with her knees”) to a kinematic model of the user and tracking data for the worktop. Here, the result of applying the rule can yield the contextual characteristic of, “hands by side,” with respect to the user's orientation. Thereafter, tracking loss mitigation system 164 can identify the corresponding user state in order to animate the user's avatar 1202 to dispose its hands 1204 by the avatar's sides, i.e., away from the worktop 1206.

As can be understood from the above, implementations of the present technology can apply to tracking loss in a user's pose for various portions of the user's body. For instance, such implementations can, via the kinematic model discussed herein, determine one or more contextual characteristics for facial (lips, eyes, etc.) dispositions of a user. That is, a user state according to such characteristics can, for example, define an emotion or gaze of the user from which animation for the user's avatar can be reinitiated once tracking for the user's pose is regained.

Reference in this specification to “implementations” (e.g., “some implementations,” “various implementations,” “one implementation,” “an implementation,” etc.) means that a particular feature, structure, or characteristic described in connection with the implementation is included in at least one implementation of the disclosure. The appearances of these phrases in various places in the specification are not necessarily all referring to the same implementation, nor are separate or alternative implementations mutually exclusive of other implementations. Moreover, various features are described which may be exhibited by some implementations and not by others. Similarly, various requirements are described which may be requirements for some implementations but not for other implementations.

As used herein, being above a threshold means that a value for an item under comparison is above a specified other value, that an item under comparison is among a certain specified number of items with the largest value, or that an item under comparison has a value within a specified top percentage value. As used herein, being below a threshold means that a value for an item under comparison is below a specified other value, that an item under comparison is among a certain specified number of items with the smallest value, or that an item under comparison has a value within a specified bottom percentage value. As used herein, being within a threshold means that a value for an item under comparison is between two specified other values, that an item under comparison is among a middle-specified number of items, or that an item under comparison has a value within a middle-specified percentage range. Relative terms, such as high or unimportant, when not otherwise defined, can be understood as assigning a value and determining how that value compares to an established threshold. For example, the phrase “selecting a fast connection” can be understood to mean selecting a connection that has a value assigned corresponding to its connection speed that is above a threshold.

As used herein, the word “or” refers to any possible permutation of a set of items. For example, the phrase “A, B, or C” refers to at least one of A, B, C, or any combination thereof, such as any of: A; B; C; A and B; A and C; B and C; A, B, and C; or multiple of any item such as A and A; B, B, and C; A, A, B, C, and C; etc.

Although the subject matter has been described in language specific to structural features and/or methodological acts, it is to be understood that the subject matter defined in the appended claims is not necessarily limited to the specific features or acts described above. Specific embodiments and implementations have been described herein for purposes of illustration, but various modifications can be made without deviating from the scope of the embodiments and implementations. The specific features and acts described above are disclosed as example forms of implementing the claims that follow. Accordingly, the embodiments and implementations are not limited except as by the appended claims.

Any patents, patent applications, and other references noted above are incorporated herein by reference. Aspects can be modified, if necessary, to employ the systems, functions, and concepts of the various references described above to provide yet further implementations. If statements or subject matter in a document incorporated by reference conflicts with statements or subject matter of this application, then this application shall control.

We claim:

1. A method of mitigating animation disruption in an artificial reality environment, the method comprising:
providing an avatar in the artificial reality environment as a representation of a user;
retrieving user pose data tracked for the user and object tracking data for one or more real-world objects;
identifying a user state, based on the user pose data and object tracking data, by:
converting the user pose data into input for a machine learning model;
applying the input to the machine learning model and, based on output from the machine learning model, obtaining a kinematic model of the user;
determining one or more contextual characteristics of the user by applying one or more rules to the kinematic model of the user and to the object tracking data; and
selecting the user state based on a mapping of contextual characteristics to user states, wherein each user state is assigned to an avatar pose;
detecting an interruption in tracking user pose; and
in response to the detecting the interruption in the tracking user pose, animating the avatar to the avatar pose assigned to the identified user state.

2. The method of claim 1,
wherein the user pose data comprises one or more of (a) inertial measurement unit (IMU) data, (b) image data, (c) depth data, or (d) any combination thereof, as captured by an artificial reality device of the user; and
wherein the object tracking data comprises image data of a real-world environment surrounding the artificial reality device of the user.

3. The method of claim 1,
wherein the kinematic model of the user defines a current body configuration of the user according to anatomical capabilities and constraints.

4. The method of claim 1,
wherein the one or more real-world objects comprise a worktop;
wherein the applying the one or more rules comprise determining whether (a) the user's hand is on the worktop based on determining if a distance between the worktop and one or more of the user's hands is zero, (b) the user's hand and elbow are on the worktop based on determining if an angle between the hand and the elbow is zero and a distance between the user's hand and elbow to the worktop is zero, (c) the user's hand is in the user's lap based on determining if the hand is disposed at a zero distance from an area between the user's waist to knees when in a sitting position, and (d) the user's hands are by the user's sides based on determining if the hands are parallel with the user's legs; and
wherein, in response to the applying the one or more rules to the kinematic model of the user and to the object tracking data, the one or more contextual characteristics each define a placement of one or more portions of the user's body with respect to another portion of the user's body and/or the worktop, and respectively correspond to the one or more rules as (e) hand on worktop, (f) hand and elbow on worktop, (g) hand in lap, and (h) hands by side.

5. The method of claim 1,
wherein the selected user state defines a configuration of one or more portions of the user's body compared to another body portion and/or a worktop, and is selected, according to the determined one or more contextual characteristics, from among states corresponding to: (l) user is at worktop, (m) user is at worktop and facing to one side, (n) user is seated at a distance from worktop, and (o) user is standing away from worktop; and
wherein the avatar poses respectively assigned to user states comprise: (p) avatar's hands placed on worktop, (q) avatar is at worktop and facing to one side, (r) avatar is seated at a distance from worktop, and (t) avatar is standing away from worktop.

6. The method of claim 1,
wherein the detecting the interruption in the tracking user pose comprises determining that an a confidence value from the machine learning model is below a predetermined threshold.

7. The method of claim 1,
wherein the method further comprises:
detecting that the interruption in tracking user pose has ended; and,
in response, animating the avatar to match a user pose based on the user pose data and the object tracking data.

8. A computing system for mitigating animation disruption in an artificial reality environment, the computing system comprising:
one or more processors; and
one or more memories storing instructions that, when executed by the one or more processors, cause the computing system to perform a process comprising:
providing an avatar for a user in the artificial reality environment;
retrieving user pose data tracked for the user and object tracking data for one or more real-world objects;
identifying a user state, based on the user pose data and object tracking data, by:
obtaining a kinematic model of the user based on a machine learning model applied to the user pose data;
determining one or more contextual characteristics of the user by applying one or more rules to the kinematic model of the user and to the object tracking data; and
selecting the user state based on a mapping of contextual characteristics to user states, wherein each user state is assigned to an avatar pose;
detecting an interruption in tracking user pose; and
in response to the detecting the interruption in the tracking user pose, animating the avatar to the avatar pose assigned to the identified user state.

9. The computing system of claim 8,
wherein the user pose data comprises one or more of (a) inertial measurement unit (IMU) data, (b) image data, (c) depth data, or (d) any combination thereof, as captured by an artificial reality device of the user; and
wherein the object tracking data comprises image data of a real-world environment surrounding the artificial reality device of the user.

10. The computing system of claim 8,
wherein the one or more real-world objects comprise a worktop;
wherein the applying the one or more rules comprise determining whether (a) the user's hand is on the worktop based on determining if a distance between the worktop and one or more of the user's hands is zero, (b) the user's hand and elbow are on the worktop based on determining if an angle between the hand and the elbow is zero and a distance between the user's hand and elbow to the worktop is zero, (c) the user's hand is in the user's lap based on determining if the hand is disposed at a zero distance from an area between the user's waist to knees when in a sitting position, and (d) the user's hands are by the user's sides based on determining if the hands are parallel with the user's legs; and
wherein, in response to the applying the one or more rules to the kinematic model of the user and to the object tracking data, the one or more contextual characteristics each define a placement of one or more portions of the user's body with respect to another portion of the user's body and/or the worktop, and respectively correspond to the one or more rules as (e) hand on worktop, (f) hand and elbow on worktop, (g) hand in lap, and (h) hands by side.

11. The computing system of claim 8,
wherein the selected user state defines a configuration of one or more portions of the user's body compared to another body portion and/or a worktop, and is selected, according to the determined one or more contextual characteristics, from among states corresponding to: (l) user is at worktop, (m) user is at worktop and facing to one side, (n) user is seated at a distance from worktop, and (o) user is standing away from worktop.

12. The computing system of claim 8,
wherein the kinematic model of the user defines a current body configuration of the user according to anatomical capabilities and constraints; and
wherein the detecting the interruption in the tracking user pose comprises determining that an a confidence value from the machine learning model is below a predetermined threshold.

13. The computing system of claim 8,
wherein the process further comprises:
detecting that the interruption in tracking user pose has ended; and,
in response, animating the avatar to match a user pose based on the user pose data and the object tracking data.

14. A machine-readable storage medium having machine-executable instructions stored thereon that, when executed by one or more processors, cause the one or more processors to perform a method for mitigating animation disruption in an artificial reality environment, the method comprising:
providing an avatar for a user in the artificial reality environment;
retrieving user pose data tracked for the user and object tracking data for one or more real-world objects;
identifying a user state, based on the user pose data and object tracking data, by:
obtaining a kinematic model of the user based on a machine learning model applied to the user pose data;
determining one or more contextual characteristics of the user by applying one or more rules to the kinematic model of the user and to the object tracking data; and
selecting the user state based on a mapping of contextual characteristics to user states, wherein each user state is assigned to an avatar pose;
detecting an interruption in tracking user pose; and
in response to the detecting the interruption in the tracking user pose, animating the avatar to the avatar pose assigned to the identified user state.

15. The machine-readable storage medium of claim 14,
wherein the user pose data comprises image data, of the user, captured by an artificial reality device of the user; and
wherein the object tracking data comprises image data of a real-world environment surrounding the artificial reality device of the user.

16. The machine-readable storage medium of claim 14,
wherein the kinematic model of the user defines a current body configuration of the user according to anatomical capabilities and constraints.

17. The machine-readable storage medium of claim 14,
wherein the one or more real-world objects comprise a worktop;
wherein the applying the one or more rules comprise determining whether (a) the user's hand is on the worktop based on determining if a distance between the worktop and one or more of the user's hands is zero, (b) the user's hand and elbow are on the worktop based on determining if an angle between the hand and the elbow is zero and a distance between the user's hand and elbow to the worktop is zero, (c) the user's hand is in the user's lap based on determining if the hand is disposed at a zero distance from an area between the user's waist to knees when in a sitting position, and (d) the user's hands are by the user's sides based on determining if the hands are parallel with the user's legs; and
wherein, in response to the applying the one or more rules to the kinematic model of the user and to the object tracking data, the one or more contextual characteristics each define a placement of one or more portions of the user's body with respect to another portion of the user's body and/or the worktop, and respectively correspond to the one or more rules as (e) hand on worktop, (f) hand and elbow on worktop, (g) hand in lap, and (h) hands by side.

18. The machine-readable storage medium of claim 14,
wherein the avatar poses respectively assigned to user states comprise: (p) avatar's hands placed on worktop, (q) avatar is at worktop and facing to one side, (r) avatar is seated at a distance from worktop, and (t) avatar is standing away from worktop.

19. The machine-readable storage medium of claim 14,
wherein the detecting the interruption in the tracking user pose comprises determining that an a confidence value from the machine learning model is below a predetermined threshold.

20. The machine-readable storage medium of claim 14,
wherein the method further comprises:
detecting that the interruption in tracking user pose has ended; and,
in response, animating the avatar to match a user pose based on the user pose data and the object tracking data.
